(19) United States
(12) Patent Application Publication
(10) Pub. No.: US 2006/0225432 A1
(43) Pub. Date: Oct. 12, 2006

(54) Supercharged open cycle gas turbine engine

(76) Inventor: Essam T. Awdalla, Raleigh, NC (US)

Correspondence Address: Essam T. Awdalla, 2309 Myron Drive Apt. F, Raleigh, NC, 27607, US

(21) Appl. No.: 11/092,408

(22) Filed: Mar. 29, 2005

(51) Int. Cl. F02C 3/04

(52) U.S. Cl. 60/792; 60/39.25

(57) ABSTRACT

The present invention provides a supercharged open cycle gas turbine engine comprising a core engine for generating shaft power output; a supercharger for increasing the density and pressure of intake air of the core engine, said supercharger includes a rotary ram-in compressor; a receiver; and a turbine having variable-area nozzle assembly; at least one conduit for communicating the supercharger's receiver with its surrounding atmospheric air, said conduit being provided with a valve for controlling the flow of air through it; at least one pressure sensor for detecting the degree of rise in the pressure of air supplied by the supercharger's compressor; means for adjusting the area of the nozzles of the supercharger's turbine according to the detected degree of rise in the air pressure; and means for adjusting the rate of fuel supply to the core engine according to the pressure level of air supplied by the supercharger's compressor.

### FIELD OF THE INVENTION

The present invention relates to a supercharged open cycle gas turbine engine and, more particularly, to a supercharged gas turbine engine with improved part-load operating efficiency, for use in helicopters, V/STOL aircrafts, land vehicles, sea vessels, and variable power-output electric generators.

### DESCRIPTION OF PRIOR ART

Supercharged open cycle gas turbine engines are disclosed in the inventor's earlier U.S. patent application Ser. No. 10/669,279 entitled “Supercharged open cycle gas turbine engine”, which provides an open cycle gas turbine engine characterized by the operator's ability to flexibly change the amount of its developed shaft power output, while maintaining high operating efficiency levels. This is achieved by changing the mass flow rate of working gases within the gas turbine engine, while maintaining both the pressure ratio between the working gases at the inlet of the turbine section of the engine and the working gases at the outlet of the said turbine section, and the temperature of the working gases at the inlet of the turbine section of the engine, at the levels providing optimum efficiency, using a supercharger including a specially designed positive-displacement rotary compressor.

Functionally, the supercharged open cycle gas turbine engine is divided into two main components: a core gas turbine engine for generating shaft power output; and a supercharger for controlling the density of the air provided to the core engine's compressor. The core engine includes a multi-stage compressor, the first stage of which being a rotary ram compressor (disclosed in the inventor's earlier International Patent Application serial number PCT/US00/17044 entitled “Rotary ram fluid pressurizing machine” and U.S. patent application Ser. No. 11/069,267 entitled “Rotary ram compressor”) or a rotary ram-in compressor (disclosed in the inventor's earlier U.S. patent application Ser. No. 10/669,514 entitled “Rotary ram-in compressor” and U.S. patent application Ser. No. 11/070,914 entitled “Radial out-flowing rotary ram-in compressor”); a combustion chamber; and a turbine. The supercharger includes a rotary positive displacement compressor; a receiver; and a turbine having variable area nozzle assembly.

In operation, air is rammed into the supercharger's compressor wherein its density and pressure are increased. The pressurized air collects in the compressor's receiver, from which it is actively swept by the first stage of the multi-stage core engine's compressor (either a rotary ram compressor or a rotary ram-in compressor), followed by further increasing its pressure within the following stages of the core engine's compressor. The fully pressurized air is introduced to the core engine's combustion chamber wherein fuel is burned, followed by introducing the combustion products to the core engine's turbine, wherein part of its energy is extracted and converted into shaft power supplied to both the core engine's compressor and to a driven mechanism. A portion of the gases discharged from the core engine's turbine are directed to the supercharger's turbine wherein part of its energy is extracted and converted into shaft power utilized in driving the supercharger's compressor.

As the pressurized air is actively swept from the compressor's receiver by the first stage of the core engine's compressor, which operates around a constant rotational speed to avoid any degradation in the overall pressure ratio level provided by the core engine's compressor, so, the volumetric rate with which pressurized air is swept from the compressor's receiver will be constant, which enables adjusting the density of air collecting within the supercharger's receiver, and hence the mass flow rate of working gases within the core engine, by adjusting the volumetric rate with which air is ingested through the feeding channels of the supercharger's compressor, which depends on the rotational speed of the supercharger's compressor. And as both the supercharger's compressor and turbine rotate at the same speed, with their rotational speed being dependent on the amount of shaft power extracted by the supercharger's turbine from the portion of the exhaust gases directed through it, so, the supercharger's compressor can be accelerated or decelerated by increasing or decreasing the portion of the exhaust gases directed through the supercharger's turbine, and thus increasing or decreasing the mass flow rate of working gases within the core engine.

In the before-mentioned “Supercharged open cycle gas turbine engine” patent application, the portion of the exhaust gases which is not directed to the supercharger's turbine is bled through a side passage provided with valve means, with the supercharger's rotor being accelerated or decelerated by decreasing or increasing the volume of the portion of the bled gases respectively. Although this markedly simplifies the overall gas turbine design, yet it entails losing a recoverable part of energy within the bled part of the exhaust gases, which if recovered will markedly improve the overall gas turbine cycle efficiency.

### SUMMARY OF THE INVENTION

Accordingly, the present invention provides a supercharged open-cycle gas turbine engine, with improved overall cycle efficiency, for use in helicopters, V/STOL aircrafts, land vehicles, sea vessels, and variable power-output electric generators.

In a preferred embodiment of the present invention, the supercharged gas turbine engine comprises a core engine for generating shaft power output, said core engine includes a multi-stage compressor, the first stage of which being either a rotary ram compressor (disclosed in the inventor's earlier International Patent Application serial number PCT/US00/17044 entitled “Rotary ram fluid pressurizing machine” and U.S. patent application Ser. No. 11/069,267 entitled “Rotary ram compressor”) or a rotary ram-in compressor (disclosed in the inventor's earlier U.S. patent application Ser. No. 10/669,514 entitled “Rotary ram-in compressor” and U.S. patent application Ser. No. 11/070,914 entitled “Radial out-flowing rotary ram-in compressor”); a supercharger for supercharging intake air of the core engine, said supercharger includes a rotary ram-in compressor; a receiver; and a turbine driven by a portion of the working gases discharged from the core engine's turbine, and having variable-area nozzle assembly; at least one conduit for communicating the supercharger's receiver with its surrounding atmospheric air, with the said conduit being provided with valve means for controlling the flow of air through it; at least one pressure sensor for detecting the degree of rise in the pressure of air supplied by the supercharger's compressor, either directly within the intake passage of the core engine's compressor, or indirectly at a selected point in-between the stages of the core engine's compressor; means for adjusting the area of the nozzles of the supercharger's turbine according to the detected degree of rise in the air pressure; means for adjusting the rate of fuel supply to the core engine according to the pressure level of air supplied by the supercharger's compressor; and means for dividing the stream of working gases discharged from the core engine's turbine into two sub-stream portions: a first sub-stream portion introduced to the supercharger's turbine; and a second sub-stream portion, with the said stream dividing means being provided with means for changing the ratio with which the said stream of working gases is divided into the said two sub-stream portions.

In operation, air is rammed through the feeding channels of the supercharger's rotary ram-in compressor, which displace it in a generally radially inward direction (when a radial in-flowing rotary ram-in compressor is used), or in a generally radially outward direction (when a radial out-flowing rotary ram-in compressor is used), to the compressor's receiver. Then, the pressurized air is actively swept from the compressor's receiver by the first stage of the multi-stage core engine's compressor (either a rotary ram compressor or a rotary ram-in compressor).

When a rotary ram compressor is used for active sweeping of air from the supercharger's compressor receiver, the static pressure rise developed within its diverging channels prevents excess flow of air from the receiver through its channels, regardless of the pressure level developed within the receiver, and when a rotary ram-in compressor is used for active sweeping of air from the supercharger's compressor receiver, the static pressure rise developed within its receiver prevents excess flow of air from the receiver of the supercharger's compressor through its feeding channels, regardless of the pressure level developed within the receiver.

The density and the pressure level of the air within the receiver of the supercharger's compressor, which is supplied to the core engine's compressor, depends on the ratio between the volumetric rate with which air is fed to the receiver by the supercharger's compressor (which depends on the number of its feeding channels and their dimensions and velocity) and the volumetric rate with which air is swept from the receiver by either a rotary ram compressor (which depends on the number of its channels, the dimensions of its channels' inlets, and their velocity) or a rotary ram-in compressor. If the volumetric rate with which air is fed to the receiver equals the volumetric rate with which it is being swept, no pressure rise occurs within the receiver, with the pressure inside it being equivalent to that of the surrounding atmospheric air pressure. If the volumetric rate with which air is fed to the receiver is greater than its sweeping volumetric rate, the density of air within the receiver, and hence its pressure, will gradually increase till an equilibrium point is reached, at which the mass flow rates of air feeding and air sweeping from the receiver are equal to one another.

As the rotary ram compressor (or the rotary ram-in compressor), through the channels of which air is being actively swept from the receiver, forms the first stage of the multi-stage core engine's compressor, with its operating rotational speed being maintained around an optimum design value to avoid degradation of the overall pressure ratio level provided by the core engine's compressor, so, the volumetric rate with which air is actively swept from the receiver of the supercharger's compressor will be constant during operation, with the density and pressure level of air within the receiver being dependent on and proportional to the volumetric rate with which air is fed to the receiver through the supercharger's compressor, which depends on the operating rotational speed of the supercharger's compressor, as described herein before.

The rotational speed of the supercharger's compressor, and hence the density of air collecting within its receiver and the mass flow rate of working gases within the core engine, depends on the amount of driving shaft power supplied to the supercharger's compressor from the supercharger's turbine, which depends on both the mass flow rate of working gases within the supercharger's turbine, and the pressure level at which these gases are provided.

In this embodiment, the stream of the working gases discharged from the core engine's turbine is divided into two sub-stream portions: a first sub-stream portion; and a second sub-stream portion. The first sub-stream portion is introduced to the supercharger's turbine, wherein part of its energy is extracted and converted into shaft power utilized in driving the supercharger's turbine and compressor. The second sub-stream portion is either introduced to another mechanically independent turbine, wherein part of its energy is extracted and converted into shaft power utilized in driving an auxiliary electric generator or any other auxiliary driven mechanism, or introduced to a variable-area thrusting nozzle, wherein part of its static energy is converted into kinetic energy used for auxiliary thrusting. Such arrangements are well known by the people experienced in the Art.

The ratio with which the stream of working gases is divided into the two sub-stream portions is to be determined experimentally for each design, depending on the amount of the working gases needed by the supercharger's turbine to extract enough shaft power to drive the supercharger's rotor at each operating rotational speed, relative to the total amount of working gases discharged from the core engine's turbine. The exact amount of shaft power extracted by the supercharger's turbine from the first sub-stream portion of working gases, at each operating rotational speed, is adjusted as needed by controlling the angle of inclination of the variable-area nozzle assembly of the supercharger's turbine.

To start the supercharged gas turbine engine of this embodiment, the valve means provided for controlling the flow of air through the conduit communicating the supercharger's receiver with its surrounding atmospheric air is opened widely, to provide free communication between the supercharger's receiver and its surrounding atmosphere, so that the pressure of air within the compressor's receiver will be equal to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine from the first sub-stream portion of the working gases discharged from the core engine's turbine and introduced to it, till the supercharger's compressor reaches a rotational speed at which the volumetric rate with which air is fed to the supercharger's receiver is equal to the volumetric rate with which it is being swept from it. At that point, the valve means provided for controlling the flow of gases through the said conduit is closed, with the working gases being provided to the core engine's compressor by the supercharger's compressor.

In operation, acceleration of the supercharger's compressor is provided by adjusting the said means provided for changing the ratio with which the stream of working gases discharged from the core engine's turbine is divided into the two sub-stream portions so that the amount of the first sub-stream portion introduced to the supercharger's turbine is increased, and thus increasing the amount of the shaft power energy extracted by the supercharger's turbine and supplied to the supercharger's compressor leading to its acceleration. Deceleration of the supercharger's compressor is provided by adjusting the said means provided for changing the ratio with which the stream of working gases discharged from the core engine's turbine is divided so that the amount of the first sub-stream portion introduced to the supercharger's turbine is decreased, and thus decreasing the amount of the shaft power energy extracted by the supercharger's turbine and supplied to the supercharger's compressor leading to its deceleration, and/or by opening the said valve means provided for controlling the flow of air through the conduit communicating the supercharger's receiver with its surrounding atmospheric air, to partially bleed the pressurized air collecting within the supercharger's compressor receiver, which will lead to an immediate drop in the mass flow rate and pressure level of the working gases provided to the core engine, and hence to the supercharger's turbine, which decreases the shaft power output provided by it to the supercharger's compressor, leading to its deceleration, as described herein before.

To maintain the temperature of the working gases at the inlet of the core engine's turbine around optimum design level, the rate of fuel supply to the combustion chamber of the core engine is adjusted according to the mass flow rate of working gases within the core engine, which is proportional to the pressure level (and density) of air provided by the supercharger's compressor. Accordingly, either the rate of fuel supply to the combustion chamber of the core engine is adjusted by spring loaded plunger means actuated by the pressure level of air in the supercharger's compressor receiver, or the degree of rise in the pressure of air provided by the supercharger's compressor is monitored by a pressure sensor, either directly within the receiver, or indirectly at a selected point in-between the stages of the core engine's compressor, which delivers a correlative signal to a linear step motor controlling the position of plunger means, which adjusts the rate of fuel supply to the combustion chamber of the core engine accordingly.

For extraction of the needed amount of energy from the working gases by the supercharger's turbine at different operating rotational speeds, the angles of inclination of the supercharger's turbine nozzles are adjusted to provide certain degrees of static pressure drop within as needed (to be determined experimentally for each design). Accordingly, the degree of rise in the pressure of air provided by the supercharger's compressor is monitored by a pressure sensor, either directly within the supercharger's receiver, or indirectly at a selected point in-between the stages of the core engine's compressor, which delivers a correlative signal to a stepping motor controlling the angle of inclination of the vanes, and thus adjusting their area as needed.

Heat exchanging means for cooling the pressurized air may be provided within the supercharger compressor's receiver, or between any two successive compressor stages, to further improve the overall cycle efficiency. Also, heat exchanging means may be provided to recover part from the heat energy within the hot working gases exhausted from the supercharger's turbine, and/or the said mechanically independent turbine which may be used to extract part of the energy of the second sub-stream portion of the working gases discharged from the core engine's turbine, and transfer it to the pressurized gases provided by the core engine's compressor before entering the core engine's combustion chamber. Such means are well known to people experienced in the Art.

In another preferred embodiment of the present invention, the supercharged gas turbine engine comprises a core engine for generating shaft power output, said core engine includes a multi-stage compressor, the first stage of which being either a rotary ram compressor or a rotary ram-in compressor; a supercharger for supercharging intake air of the core engine, said supercharger includes a rotary ram-in compressor; a receiver; and a turbine driven by the working gases discharged from the core engine's turbine and having variable-area nozzle assembly; at least one conduit for communicating the supercharger's receiver with its surrounding atmospheric air, with the said conduit being provided with valve means for controlling the flow of air through it; at least one pressure sensor for detecting the degree of rise in the pressure of air supplied by the supercharger's compressor, either directly within the intake passage of the core engine's compressor, or indirectly at a selected point in-between the stages of the core engine's compressor; means for adjusting the area of the nozzles of the supercharger's turbine according to the detected degree of rise in the air pressure; and means for adjusting the rate of fuel supply to the core engine according to the pressure level of air supplied by the supercharger's compressor.

The operating principals for the supercharger's compressor, the core engine, and the means for adjusting the rate of fuel supply to the core engine in this embodiment are similar to those of the previously described embodiment herein before, However, all the working gases discharged from the core engine's turbine are introduced to the supercharger's turbine, and thus in operation, the amount of the shaft power extracted by the supercharger's turbine will be much more than that needed to drive the supercharger's compressor. Thus, in this embodiment, an auxiliary electric motor-generator (which is employed as an electric motor to accelerate and/or to start the supercharger, and as an electric generator during the core engine's steady power output operating conditions), an auxiliary electric generator or any other auxiliary driven mechanism is connected to the supercharger's shaft, through torque transmitting means, to utilize the extra power provided by the supercharger's turbine, and thus adjusting the power supplied to the supercharger's compressor, and hence its rotational speed, as needed.

In operation, the angles of inclination of the supercharger's turbine nozzles are adjusted to provide the needed degrees of static pressure drop within the supercharger's turbine, to enable extracting the required amount of energy from the working gases by the supercharger's turbine, to drive both the supercharger's rotor and the driven auxiliary mechanism, at different supercharger's operating rotational speeds. Accordingly, the degree of rise in the pressure of air provided by the supercharger's compressor is monitored by a pressure sensor, either directly within the supercharger's receiver, or indirectly at a selected point in-between the stages of the core engine's compressor, which delivers a correlative signal to a stepping motor controlling the angle of inclination of the vanes, and thus adjusting their area accordingly.

To start the supercharged gas turbine engine, when an auxiliary electric motor-generator is used, either the auxiliary electric motor-generator is employed as an electric motor to start the supercharger, or the said valve means provided for controlling the flow of air through the conduit communicating the supercharger's receiver with its surrounding atmospheric air is opened widely, to provide free communication between the supercharger's receiver and its surrounding atmospheric air, so that the pressure of air within the compressor's receiver will be equal to that of the surrounding atmospheric pressure, to avoid chocking of the core engine's compressor, then, the core engine is started using conventional starting means. Once the core engine starts running, the supercharger's rotor will start to accelerate by the shaft power extracted by the supercharger's turbine from the working gases discharged from the core engine's turbine and introduced to it, till the supercharger's compressor reaches a rotational speed at which the volumetric rate with which air is fed to the receiver is equal to the volumetric rate with which it is being swept from it. At that point, the said valve within the means provided for communicating the supercharger's receiver with the surrounding atmospheric air is closed, with working gases being provided to the core engine's compressor by the supercharger's compressor.

In operation, when an auxiliary electric motor-generator is used, acceleration of the supercharger's compressor is provided either by operating the electric motor-generator as a motor, with the power provided by it being added to the power provided by the supercharger's turbine, leading to acceleration of the supercharger, or by disconnecting the torque transmitting means through which the excess power provided by the supercharger's turbine is provided to the electric motor-generator, and thus, all the available shaft power energy provided by the supercharger's turbine will be supplied to the supercharger's compressor leading to its acceleration. The supercharger's compressor is decelerated by opening the said valve means provided for controlling the flow of air through the conduit communicating the supercharger's receiver with its surrounding atmospheric air, to partially bleed the pressurized air collecting within the supercharger's receiver, which will lead to immediate drop in the density and pressure level of pressurized air within the receiver, leading to a decrease in the mass flow rate and pressure level of working gases within the core engine, which results in a drop in the mass flow rate and pressure level of the working gases provided to the supercharger's turbine, which decreases the shaft power output provided by it to the supercharger's compressor and the electric motor-generator, leading to their deceleration. This deceleration arrangement also provides momentary decrease in the shaft power output provided by the core engine, due to the associated immediate decrease in the mass flow rate of working gases within the core engine.

To start the supercharged gas turbine engine, when an auxiliary electric generator or any other auxiliary driven mechanism is used, the said valve means provided for controlling the flow of air through the conduit communicating the supercharger's receiver with its surrounding atmospheric air is opened widely, to provide free communication between the supercharger's receiver and its surrounding atmospheric air, so that the pressure of air within the compressor's receiver will be equal to that of the surrounding atmospheric pressure, to avoid chocking of the core engine's compressor, then, the core engine is started using conventional starting means. Once the core engine starts running, the supercharger's rotor will start to accelerate by the shaft power extracted by the supercharger's turbine from the working gases discharged from the core engine's turbine and introduced to it, till the supercharger's compressor reaches a rotational speed at which the volumetric rate with which air is fed to the receiver is equal to the volumetric rate with which it is being swept from it. At that point, the valve means provided for controlling the flow of gases through the said conduit is closed, with working gases being provided to the core engine's compressor by the supercharger's compressor.

In operation, when an auxiliary electric generator or any other auxiliary driven mechanism is used, acceleration of the supercharger's compressor is provided by disconnecting the torque transmitting means through which the excess power provided by the supercharger's turbine is provided to the auxiliary driven mechanism, and thus, all the available shaft power energy provided by the supercharger's turbine will be supplied to the supercharger's compressor leading to its acceleration. Deceleration of the supercharger's compressor is provided by opening the said valve means provided for controlling the flow of air through the conduit communicating the supercharger's receiver with its surrounding atmospheric air, to partially bleed the pressurized air collecting within the supercharger's compressor receiver, which will lead to an immediate drop in the mass flow rate and pressure level of the working gases provided to the supercharger's turbine, which decreases the shaft power output provided by it to the supercharger's compressor and the auxiliary driven mechanism, leading to their deceleration, as described herein before.

To further improve the overall cycle efficiency, heat exchanging means may also be provided for cooling the pressurized air within the supercharger compressor's receiver or between any two successive compressor stages, and/or for recovering part of the heat energy within the hot working gases exhausted from the supercharger's turbine, and transferring it to the pressurized gases provided by the core engine's compressor before entering the core engine's combustion chamber. Such means are well known to people experienced in the Art.

### BRIEF DESCRIPTION OF THE DRAWINGS

The description of the objects, features and advantages of the present invention, will be more fully appreciated by reference to the following detailed description of the exemplary embodiments in accordance with the accompanying drawings, wherein:

FIG. 1 is a diagrammatic representation of the operating cycle of an open cycle supercharged gas turbine engine in accordance with the present invention.

FIG. 2 is a schematic representation of an arrangement of control means used in the supercharged gas turbine engine of FIG. 1.

FIG. 3 is a sectional view in a schematic representation of an exemplary embodiment of a supercharger used for supercharging intake air of a core gas turbine engine, in accordance with the present invention.

FIG. 4 is a cross sectional view, taken at the plane of line 4-4 in FIG. 3.

FIG. 5 is a cross sectional view, taken at the plane of line 5-5 in FIG. 3.

FIG. 6 is a diagrammatic representation of the operating cycle of another open cycle supercharged gas turbine engine in accordance with the present invention.

FIG. 7 is a schematic representation of an arrangement of control means used in the supercharged gas turbine engine of FIG. 6.

FIG. 8 is a diagrammatic representation of the operating cycle of another open cycle supercharged gas turbine engine in accordance with the present invention.

FIG. 9 is a schematic representation of an arrangement of control means used in the supercharged gas turbine engine of FIG. 8.

FIG. 10 is a diagrammatic representation of the operating cycle of another open cycle supercharged gas turbine engine in accordance with the present invention.

FIG. 11 is a schematic representation of an arrangement of control means used in the supercharged gas turbine engine of FIG. 10.

### DETAILED DESCRIPTION OF THE PREFERRED EMBODIMENTS

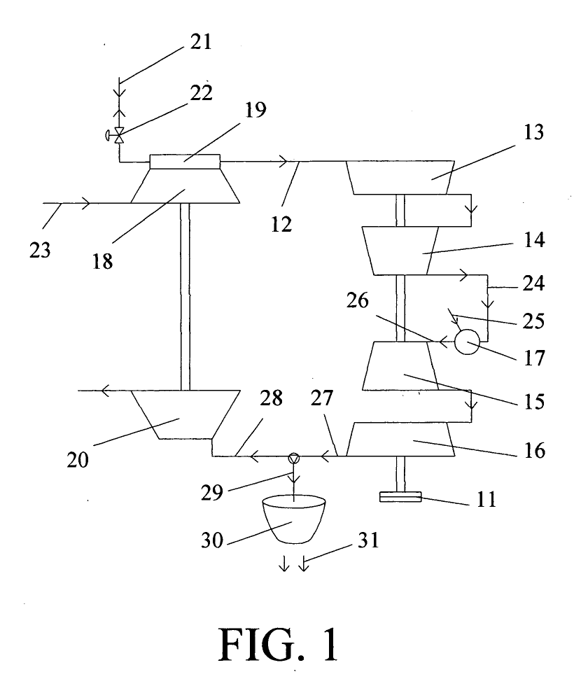

FIG. 1 is a diagrammatic representation of the operating cycle of an open cycle supercharged gas turbine engine in accordance with the present invention.

Functionally, the supercharged gas turbine engine is divided into two main components: a core gas turbine engine for generating shaft power output (11), and a supercharger for supercharging intake air (12) of the core engine. The core engine includes a multi-stage compressor (13,14), the first stage of which (13) being a rotary ram compressor or a rotary ram-in compressor; a turbine (15) including a free power turbine stage (16); and a combustion chamber (17). The supercharger includes a rotary positive displacement compressor (18); a receiver (19); and a turbine (20) having variable area nozzle assembly. The supercharged gas turbine engine also includes a conduit (21) for communicating the supercharger's receiver (19) with its surrounding atmospheric air, with the said conduit (21) being provided with valve means (22) for controlling the flow of air through it.

In operation, air (23) is rammed into the supercharger's compressor (18) wherein its density and pressure are increased. The pressurized air (12) is fed to the core engine's compressor (13, 14) for further increasing its static pressure. The fully pressurized air (24) is introduced to the combustion chamber (17) wherein fuel (25) is burned. The combustion products (26) are introduced to the core engine's turbine (15, 16) wherein part of its energy is extracted and converted into shaft power supplied to both the core engine's compressor (13,14) and to the driven mechanism (11). Gases (27) discharged from the core engine's turbine (16) are divided into two sub-stream portions: a first sub-stream portion (28) directed to the supercharger's turbine (20) wherein part of its energy is extracted and converted into shaft power used in driving the supercharger's compressor (18), and a second sub-stream portion (29) introduced to a variable-area thrusting nozzle (30), wherein part of its static energy is converted into kinetic energy used for auxiliary thrusting (31).

The volumetric rate with which air (23) is ingested by the supercharger's compressor (18) is adjusted by changing the operating rotational speed of supercharger's compressor in response to the amount of shaft power provided to it by the supercharger's turbine (20). Accordingly, the supercharger's compressor (18) can be accelerated by increasing the amount of the first sub-stream portion of the working gases (28) introduced to the supercharger's turbine (20), and thus increasing the amount of the shaft power energy extracted by the supercharger's turbine (20) and supplied to the supercharger's compressor (18) leading to its acceleration. Deceleration of the supercharger's compressor (18) is provided by decreasing the amount of the first sub-stream portion of working gases (28) introduced to the supercharger's turbine (20), and thus decreasing the amount of the shaft power energy extracted by the supercharger's turbine (20) and supplied to the supercharger's compressor (18) leading to its deceleration, and/or by opening the valve means (22) provided for controlling the flow of air through the conduit (21) communicating the supercharger's receiver (19) with its surrounding atmospheric air, to partially bleed the pressurized air collecting within the supercharger's compressor receiver (19), which will lead to immediate drop in the mass flow rate and pressure level of the working gases provided to the core engine (12), and hence to the supercharger's turbine (20), which decreases the shaft power output provided by it to the supercharger's compressor (18).

The pressurized air (12) provided by the supercharger's compressor is actively swept by the rotary ram compressor or the rotary ram-in compressor stage (13) of the core engine, with the density and pressure of the pressurized air (12) supplied to the core engine's compressor (13) being self adjusted according to the ratio between the air feeding and sweeping volumetric rates to and from the supercharger's receiver (19), and with the mass flow rate of working gases within the core engine and the amount of its developed shaft power output being adjusted accordingly.

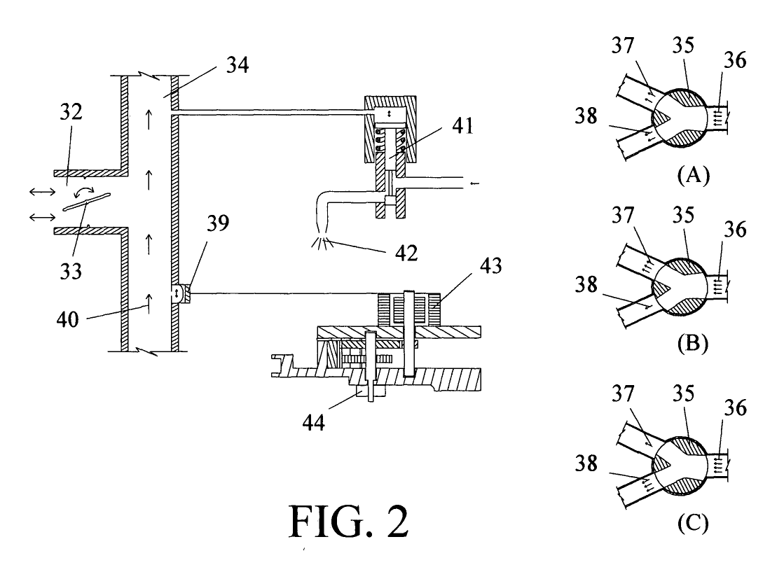

FIG. 2 is a schematic representation of an arrangement of control means used in the supercharged gas turbine engine of FIG. 1.

The arrangement of control means comprises a conduit (32), having a Butterfly valve (33) within it, for communicating the supercharger's receiver (34) with its surrounding atmospheric air; a diverter valve (35), for controlling the ratio with which the stream of the working gases discharged from the core engine's turbine (36) is divided into two sub-stream portions (37, 38); a pressure sensor (39) for monitoring the pressure of air (40) provided by the supercharger's compressor; a spring loaded plunger (41) actuated by the pressure level of air (40) in the supercharger's receiver (34) to adjust the rate of fuel supply (42) to the core engine; and a stepping motor (43) controlling the angle of inclination of the vanes (44) of the supercharger's turbine.

To start the supercharged gas turbine engine of this embodiment, the Butterfly valve (33) is widely opened, to provide free communication between the supercharger's receiver (34) and its surrounding atmosphere, and thus, the pressure of air within the supercharger's receiver (34) will be equivalent to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine from the first sub-stream portion of the working gases (37) discharged from the core engine's turbine and introduced to it, till the supercharger's compressor reaches a rotational speed at which the volumetric rate with which air is fed to the supercharger's receiver is equal to the volumetric rate with which it is being swept from it. At that point, the Butterfly valve (33) is closed, with the working gases being provided to the core engine's compressor by the supercharger's compressor.

During the core engine's steady power output operating conditions, the diverter valve (35) is adjusted so that the ratio with which the stream of the working gases discharged from the core engine's turbine (36) is divided into two sub-stream portions (37, 38) is convenient for extracting enough shaft power by the supercharger's turbine, from the first sub-stream portion, to drive the supercharger's compressor (valve position A). To accelerate the supercharger's compressor, the diverter valve (35) is adjusted to increase the amount of the first sub-stream portion (37) introduced to the supercharger's turbine (valve position B), and thus increasing the amount of the shaft power energy extracted by the supercharger's turbine and supplied to the supercharger's compressor leading to its acceleration. Deceleration of the supercharger's compressor is provided by adjusting the diverter valve (35) to decrease the amount of the first sub-stream portion (37) introduced to the supercharger's turbine (valve position C), and thus decreasing the amount of the shaft power energy extracted by the supercharger's turbine and supplied to the supercharger's compressor leading to its deceleration, and/or by opening the Butterfly valve (33) to partially bleed the pressurized air (40) collecting within the supercharger's compressor receiver (34), which will lead to immediate drop in the mass flow rate and pressure level of the working gases provided to the core engine and hence to the supercharger's turbine, which decreases the shaft power output provided by it to the supercharger's compressor, leading to its deceleration, as described herein before.

The pressure sensor (39) monitors the pressure of air (40) provided by the supercharger's compressor and sends correlative signals to the stepping motor (43) controlling the angle of inclination of the vanes (44) of the supercharger's turbine.

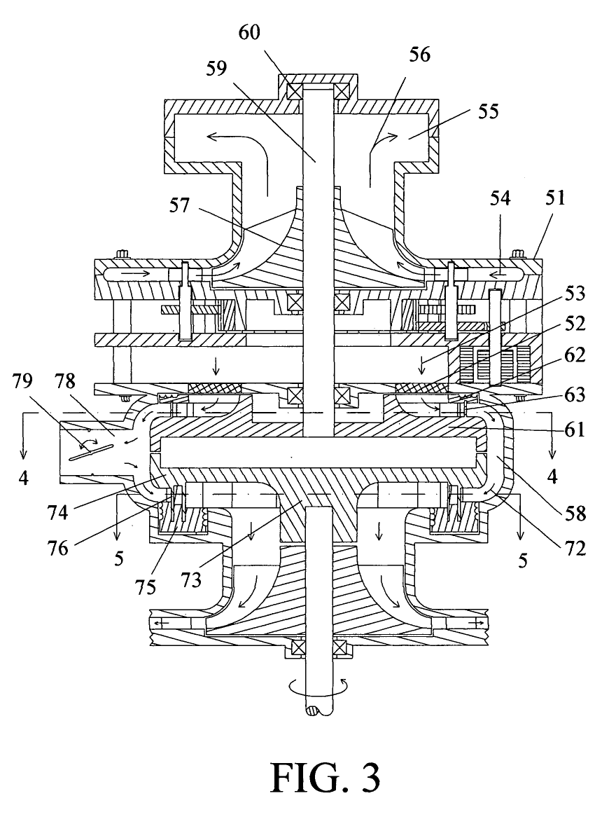

FIG. 3 is a sectional view in a schematic representation of an exemplary embodiment of a supercharger used for supercharging intake air of a core gas turbine engine, in accordance with the present invention.

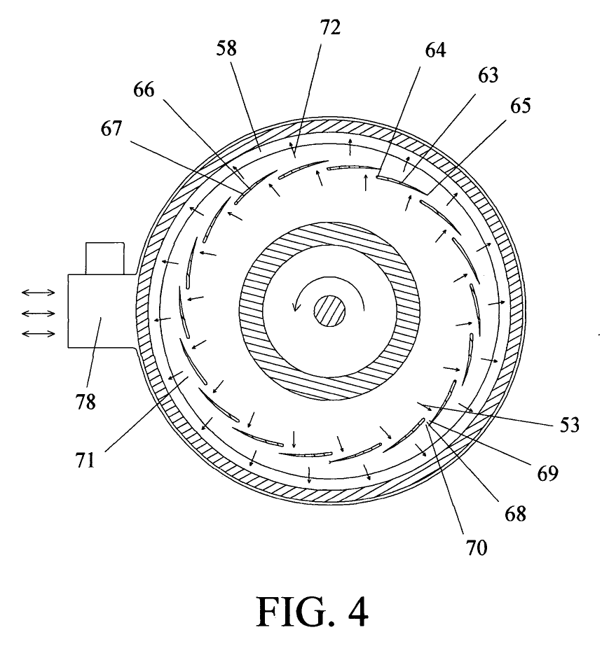

The main components of the supercharger in this embodiment are a stationary casing (51) having a first inlet passage (52) for admission of air (53); a second inlet passage for admission of the gases (54) discharged from the turbine of the core engine (not shown in the drawing for simplicity); an exit passage (55) for discharge of exhaust gases (56) discharged from the supercharger's turbine (57); a receiver (58); and a conduit (78), having a Butterfly valve (79) within it, for communicating the supercharger's receiver (58) with its surrounding atmospheric air; a drive shaft (59) supported for rotation in a given direction inside the casing by an arrangement of bearings (60); a supercharger's turbine (57) housed inside the casing and secured for rotation with the drive shaft (59); and a supercharger's compressor rotor assembly housed inside the casing and secured for rotation with the drive shaft (59). The supercharger's compressor rotor assembly comprises a first disk (61) secured for rotation with the drive shaft (59) and lying in a first plane transverse to the rotational axis of the drive shaft; a second disk (62) having a large open center and a widened rim, and lying in a second plane transverse to the rotational axis of the drive shaft, with the inner surfaces of the two disks defining an annular space in-between; and a plurality of vanes (63) arranged circumferentially within said annular space, each vane attached to both disks defining the annular space. As shown in FIG. 4 which is a cross sectional view, taken at the plane of line 4-4 in FIG. 3, each vane has a leading edge (64), a trailing edge (65), a concave surface (66) and a convex surface (67), with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +2 to about −18 degrees, the opposing parts of the surfaces of each two adjacent vanes along with the opposing parts of the two disks' surfaces confined between the opposing parts of the surfaces of each two adjacent vanes defining a feeding channel (68) between them, each feeding channel (68) having an inlet (69) communicating with the inlet passage of the compressor (52), and an outlet (70) communicating with the supercharger's compressor receiver (58).

To start the supercharged gas turbine engine of this embodiment, the Butterfly valve (79) within the conduit (78) communicating the supercharger's receiver (58) with its surrounding atmospheric air is opened, to provide free communication between the supercharger's receiver (58) and its surrounding atmosphere, and thus, the pressure of air within the compressor's receiver (58) will be equivalent to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine (57) from the working gases discharged from the core engine's turbine and introduced to it, till the supercharger's compressor reaches a rotational speed at which the volumetric rate with which air is fed to the supercharger's receiver (58) is equal to the volumetric rate with which it is being swept from it. At that point, the Butterfly valve (79) is closed, with the working gases being provided to the core engine's compressor by the supercharger's compressor.

In operation, air (53) is rammed through the feeding channels (68) of the supercharger's compressor, which direct it to the relatively outer part of the annular space (71), wherein the rammed in air is first compressed by both the pressurized air (72) collecting within the compressor's receiver (58) and by the reaction force developed on the free parts of the convex surfaces of the vanes next to the outlets of the feeding channels (67), then, the pressurized freshly introduced air is displaced in a generally radial outward direction to the receiver (58) by the relatively outer free parts of the convex surfaces of the vanes (67). The pressurized air (72) is actively swept from the receiver (58) by a rotary ram compressor (73), which forms the first stage of the multi-stage core engine's compressor.

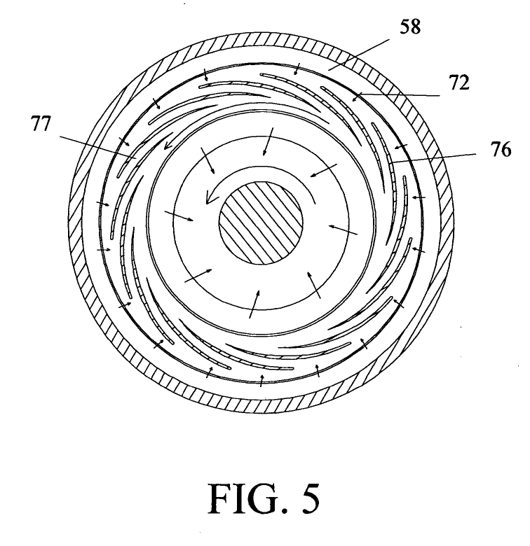

The rotary ram compressor (73) includes two disks (74,75), defining an annular space in-between, and a plurality of vanes (76) arranged circumferentially within said annular space. And as shown in FIG. 5, which is a cross sectional view, taken at the plane of line 5-5 in FIG. 3, the opposing parts of each two adjacent vanes define a diverging channel (77) in-between, through which air is actively swept from the receiver (58).

A rotary ram compressor (73) is used for active sweeping of air from the supercharger's compressor receiver, as the static pressure rise developed within its diverging channels (77) prevents excess flow of air from the receiver through its channels (77), regardless of the pressure level developed within the receiver (58), with the density and the pressure level of the air within the receiver (58) being dependant on the ratio between the volumetric rate with which air is fed to it by the supercharger's compressor and the volumetric rate with which air is swept from it by the rotary ram compressor (73).

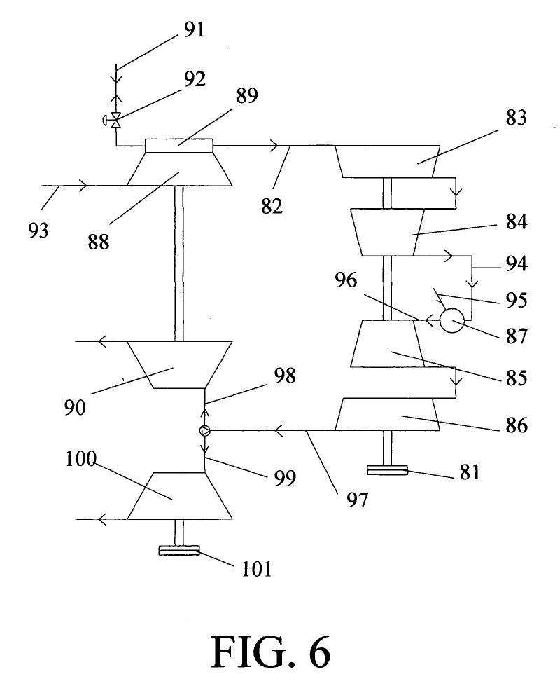

FIG. 6 is a diagrammatic representation of the operating cycle of another open cycle supercharged gas turbine engine in accordance with the present invention.

Functionally, the supercharged gas turbine engine is divided into two main components: a core gas turbine engine for generating shaft power output (81), and a supercharger for supercharging intake air (82) of the core engine. The core engine includes a multi-stage compressor (83,84), the first stage of which (83) being a rotary ram compressor or a rotary ram-in compressor; a turbine (85) including a free power turbine stage (86); and a combustion chamber (87). The supercharger includes a rotary positive displacement compressor (88); a receiver (89); and a turbine (90) having variable area nozzle assembly. The supercharged gas turbine engine also includes a conduit (91) for communicating the supercharger's receiver (89) with its surrounding atmospheric air, with the said conduit (91) being provided with valve means (92) for controlling the flow of air through it.

In operation, air (93) is rammed into the supercharger's compressor (88) wherein its density and pressure are increased. The pressurized air (82) is fed to the core engine's compressor (83, 84) for further increasing its static pressure. The fully pressurized air (94) is introduced to the combustion chamber (87) wherein fuel (95) is burned. The combustion products (96) are introduced to the core engine's turbine (85, 86) wherein part of its energy is extracted and converted into shaft power supplied to both the core engine's compressor (83,84) and to the driven mechanism (81). Gases (97) discharged from the core engine's turbine (86) are divided into two sub-stream portions: a first sub-stream portion (98) directed to the supercharger's turbine (90) wherein part of its energy is extracted and converted into shaft power used in driving the supercharger's compressor (88), and a second sub-stream portion (99) introduced to another mechanically independent turbine (100), wherein part of its energy is extracted and converted into shaft power utilized in driving an auxiliary electric generator or any other auxiliary driven mechanism (101).

The volumetric rate with which air (93) is ingested by the supercharger's compressor (88) is adjusted by changing the operating rotational speed of supercharger's compressor in response to the amount of shaft power provided to it by the supercharger's turbine (90). Accordingly, the supercharger's compressor (88) can be accelerated by increasing the amount of the first sub-stream portion of the working gases (98) introduced to the supercharger's turbine (90), and thus increasing the amount of the shaft power energy extracted by the supercharger's turbine (90) and supplied to the supercharger's compressor (88) leading to its acceleration. Deceleration of the supercharger's compressor (88) is provided by decreasing the amount of the first sub-stream portion of working gases (98) introduced to the supercharger's turbine (90), and thus decreasing the amount of the shaft power energy extracted by the supercharger's turbine (90) and supplied to the supercharger's compressor (88) leading to its deceleration, and/or by opening the valve means (92) provided for controlling the flow of air through the conduit (91) communicating the supercharger's receiver (89) with its surrounding atmospheric air, to partially bleed the pressurized air collecting within the supercharger's compressor receiver (89), which will lead to immediate drop in the mass flow rate and pressure level of the working gases (82) provided to the core engine, and hence to the supercharger's turbine (90), which decreases the shaft power output provided by it to the supercharger's compressor (88).

The pressurized air (82) provided by the supercharger's compressor is actively swept by the rotary ram compressor or the rotary ram-in compressor stage (83) of the core engine, with the density and pressure of the pressurized air (82) supplied to the core engine's compressor (83) being self adjusted according to the ratio between the air feeding and sweeping volumetric rates to and from the supercharger's receiver (89), and with the mass flow rate of working gases within the core engine and the amount of its developed shaft power output being adjusted accordingly.

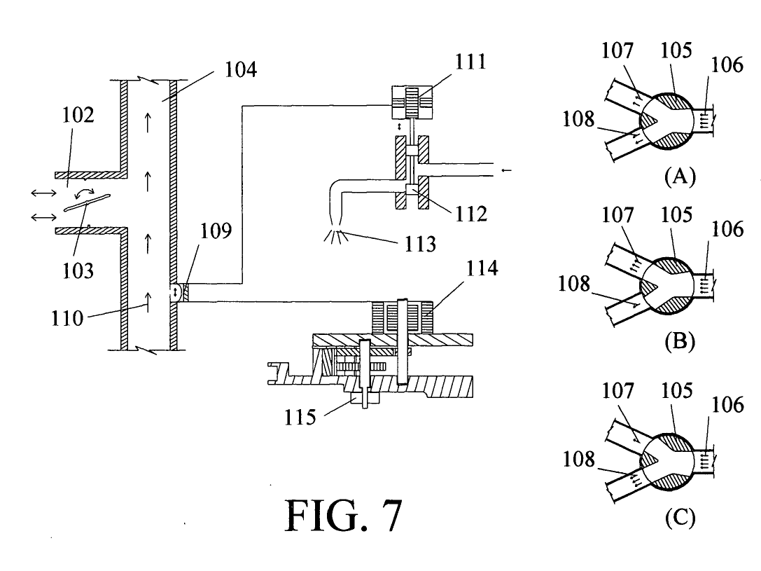

FIG. 7 is a schematic representation of an arrangement of control means used in the supercharged gas turbine engine of FIG. 6.

The arrangement of control means comprises a conduit (102), having a Butterfly valve (103) within it, for communicating the supercharger's receiver (104) with its surrounding atmospheric air; a diverter valve (105), for controlling the ratio with which the stream of the working gases discharged from the core engine's turbine (106) is divided into two sub-stream portions (107, 108); a pressure sensor (109) for monitoring the pressure of air (110) provided by the supercharger's compressor; a linear step motor (111) controlling the position of a plunger (112) which adjusts the rate of fuel supply (113) to the core engine; and a stepping motor (114) controlling the angle of inclination of the vanes (115) of the supercharger's turbine.

To start the supercharged gas turbine engine of this embodiment, the Butterfly valve (103) is widely opened, to provide free communication between the supercharger's receiver (104) and its surrounding atmosphere, and thus, the pressure of air within the supercharger's receiver (104) will be equivalent to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine from the first sub-stream portion of the working gases (107) discharged from the core engine's turbine and introduced to it, till the supercharger's compressor reaches a rotational speed at which the volumetric rate with which air is fed to the supercharger's receiver is equal to the volumetric rate with which it is being swept from it. At that point, the Butterfly valve (103) is closed, with the working gases being provided to the core engine's compressor by the supercharger's compressor.

During the core engine's steady power output operating conditions, the diverter valve (105) is adjusted so that the ratio with which the stream of the working gases discharged from the core engine's turbine (106) is divided into two sub-stream portions (107, 108) is convenient for extracting enough shaft power by the supercharger's turbine, from the first sub-stream portion, to drive the supercharger's compressor (valve position A). To accelerate the supercharger's compressor, the diverter valve (105) is adjusted to increase the amount of the first sub-stream portion (107) introduced to the supercharger's turbine (valve position B), and thus increasing the amount of the shaft power energy extracted by the supercharger's turbine and supplied to the supercharger's compressor leading to its acceleration. Deceleration of the supercharger's compressor is provided by adjusting the diverter valve (105) to decrease the amount of the first sub-stream portion (107) introduced to the supercharger's turbine (valve position C), and thus decreasing the amount of the shaft power energy extracted by the supercharger's turbine and supplied to the supercharger's compressor leading to its deceleration, and/or by opening the Butterfly valve (103) to partially bleed the pressurized air (110) collecting within the supercharger's compressor receiver (104), which will lead to immediate drop in the mass flow rate and pressure level of the working gases provided to the core engine and hence to the supercharger's turbine, which decreases the shaft power output provided by it to the supercharger's compressor, leading to its deceleration, as described herein before.

The pressure sensor (109) monitors the pressure of air (110) provided by the supercharger's compressor and sends correlative signals to both the linear step motor (111) and the stepping motor (114) controlling the rate of fuel supply (113) to the core engine and the angle of inclination of the vanes (115) of the supercharger's turbine respectively.

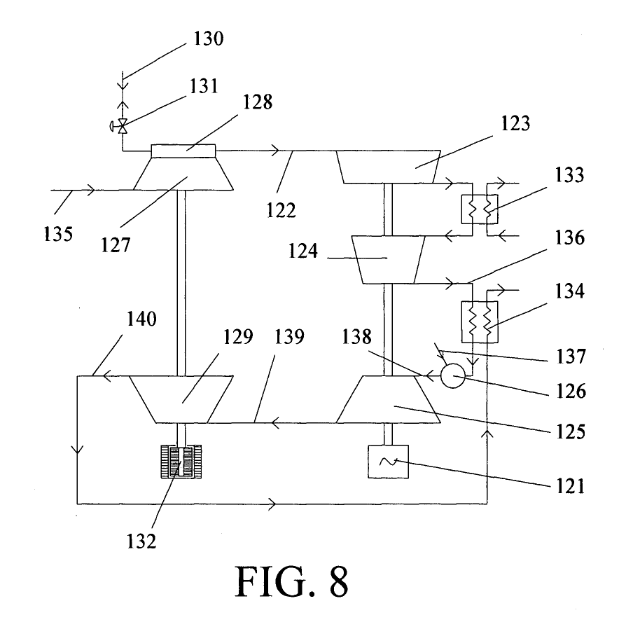

FIG. 8 is a diagrammatic representation of the operating cycle of another open cycle supercharged gas turbine engine in accordance with the present invention.

Functionally, the supercharged gas turbine engine is divided into two main components: a core gas turbine engine for generating shaft power output (121), and a supercharger for supercharging intake air (122) of the core engine. The core engine includes a multi-stage compressor (123,124), the first stage of which (123) being a rotary ram compressor or a rotary ram-in compressor; a turbine (125); and a combustion chamber (126). The supercharger includes a rotary positive displacement compressor (127); a receiver (128); and a turbine (129) having variable area nozzle assembly. The supercharged gas turbine engine also includes a conduit (130) for communicating the supercharger's receiver (128) with its surrounding atmospheric air, with the said conduit (130) being provided with valve means (131) for controlling the flow of air through it. An auxiliary electric motor-generator (132) is also connected to the supercharger's shaft, through torque transmitting means, to utilize the extra power provided by the supercharger's turbine (129). Also, Heat exchangers (133,134) are provided to cool the pressurized air provided by the first core engine's compressor stage (123) prior to its admission to the following core engine's compressor stage (124), and to recover part of the heat energy within the hot working gases (140) exhausted from the supercharger's turbine (129), and transferring it to the pressurized gases (136) provided by the core engine's compressor (124) before entering the core engine's combustion chamber (126).

In operation, air (135) is rammed into the supercharger's compressor (127) wherein its density and pressure are increased. The pressurized air (122) is fed to the core engine's compressor (123, 124) for further increasing its static pressure. The fully pressurized air (136) is introduced to the combustion chamber (126) wherein fuel (137) is burned. The combustion products (138) are introduced to the core engine's turbine (125) wherein part of its energy is extracted and converted into shaft power supplied to both the core engine's compressor (123,124) and to the driven mechanism (121). Gases (139) discharged from the core engine's turbine (125) are directed to the supercharger's turbine (129) wherein part of its energy is extracted and converted into shaft power used in driving the supercharger's compressor (127) and the auxiliary electric motor-generator (132).

The volumetric rate with which air (135) is ingested by the supercharger's compressor (127) is adjusted by changing the operating rotational speed of supercharger's compressor in response to the amount of shaft power provided to it by the supercharger's turbine (129). Accordingly, acceleration of the supercharger's compressor (127) is provided by operating the electric motor-generator (132) as a motor, with the power provided by it being added to the power provided by the supercharger's turbine (129), leading to acceleration of the supercharger's compressor. The supercharger's compressor (127) is decelerated by opening the valve means (131) controlling the flow of air through the conduit (130) to partially bleed the pressurized air collecting within the supercharger's receiver (128), which will lead to immediate drop in the density and pressure level of pressurized air within the receiver (128), leading to a decrease in the mass flow rate and pressure level of working gases within the core engine, which results in a drop in the mass flow rate and pressure level of the working gases provided to the supercharger's turbine (129), which decreases the shaft power output provided by it to the supercharger's compressor (127) and the electric motor-generator (132), leading to their deceleration.

The pressurized air (122) provided by the supercharger's compressor is actively swept by the rotary ram compressor or the rotary ram-in compressor stage (123) of the core engine, with the density and pressure of the pressurized air (122) supplied to the core engine's compressor (123) being self adjusted according to the ratio between the air feeding and sweeping volumetric rates to and from the supercharger's receiver (128), and with the mass flow rate of working gases within the core engine and the amount of its developed shaft power output being adjusted accordingly.

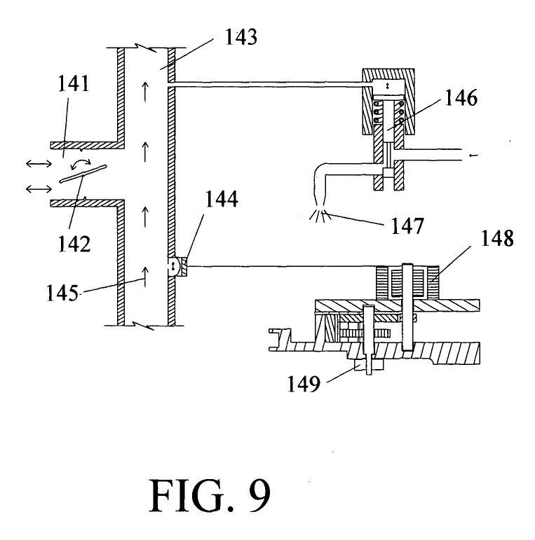

FIG. 9 is a schematic representation of an arrangement of control means used in the supercharged gas turbine engine of FIG. 8.

The arrangement of control means comprises a conduit (141), having a Butterfly valve (142) within it, for communicating the supercharger's receiver (143) with its surrounding atmospheric air; a pressure sensor (144) for monitoring the pressure of air (145) provided by the supercharger's compressor; a spring loaded plunger (146) actuated by the pressure level of air (145) in the supercharger's receiver (143) to adjust the rate of fuel supply (147) to the core engine; and a stepping motor (148) controlling the angle of inclination of the vanes (149) of the supercharger's turbine.

To start the supercharged gas turbine engine of this embodiment, the Butterfly valve (142) is widely opened, to provide free communication between the supercharger's receiver (143) and its surrounding atmosphere, and thus, the pressure of air within the supercharger's receiver (143) will be equivalent to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine from the working gases discharged from the core engine's turbine and introduced to it, till the supercharger's compressor reaches a rotational speed at which the volumetric rate with which air is fed to the supercharger's receiver is equal to the volumetric rate with which it is being swept from it. At that point, the Butterfly valve (142) is closed, with the working gases being provided to the core engine's compressor by the supercharger's compressor.

To accelerate the supercharger's compressor, the electric motor-generator is operated as a motor, with the power provided by it being added to the power provided by the supercharger's turbine, leading to acceleration of the supercharger's compressor, as discussed herein before. Deceleration of the supercharger's compressor is provided by opening the Butterfly valve (142) to partially bleed the pressurized air (145) collecting within the supercharger's compressor receiver (143), which will lead to immediate drop in the mass flow rate and pressure level of the working gases provided to the core engine and hence to the supercharger's turbine, which decreases the shaft power output provided by it to the supercharger's compressor, leading to its deceleration, as described herein before.

The pressure sensor (144) monitors the pressure of air (145) provided by the supercharger's compressor and sends correlative signals to the stepping motor (148) controlling the angle of inclination of the vanes (149) of the supercharger's turbine.

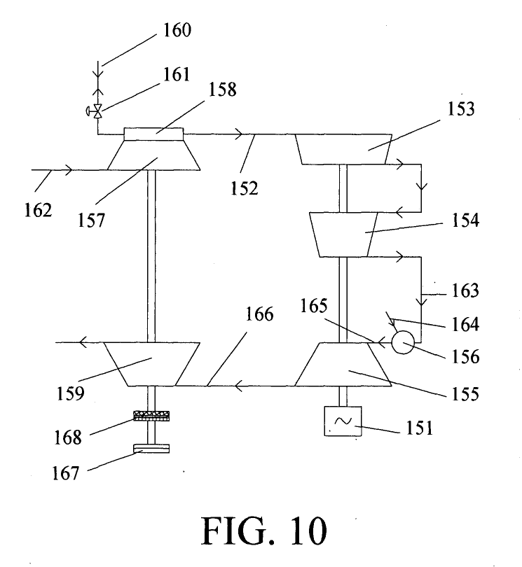

FIG. 10 is a diagrammatic representation of the operating cycle of another open cycle supercharged gas turbine engine in accordance with the present invention.

Functionally, the supercharged gas turbine engine is divided into two main components: a core gas turbine engine for generating shaft power output (151), and a supercharger for supercharging intake air (152) of the core engine. The core engine includes a multi-stage compressor (153,154), the first stage of which (153) being a rotary ram compressor or a rotary ram-in compressor; a turbine (155); and a combustion chamber (156). The supercharger includes a rotary positive displacement compressor (157); a receiver (158); and a turbine (159) having variable area nozzle assembly. The supercharged gas turbine engine also includes a conduit (160) for communicating the supercharger's receiver (158) with its surrounding atmospheric air, with the said conduit (160) being provided with valve means (161) for controlling the flow of air through it.

In operation, air (162) is rammed into the supercharger's compressor (157) wherein its density and pressure are increased. The pressurized air (152) is fed to the core engine's compressor (153, 154) for further increasing its static pressure. The fully pressurized air (163) is introduced to the combustion chamber (156) wherein fuel (164) is burned. The combustion products (165) are introduced to the core engine's turbine (155) wherein part of its energy is extracted and converted into shaft power supplied to both the core engine's compressor (153,154) and to the driven mechanism (151). Gases (166) discharged from the core engine's turbine (155) are directed to the supercharger's turbine (159) wherein part of its energy is extracted and converted into shaft power used in driving the supercharger's compressor (157) and an auxiliary driven mechanism (167) through torque transmitting means (168).

The volumetric rate with which air (162) is ingested by the supercharger's compressor (157) is adjusted by changing the operating rotational speed of supercharger's compressor in response to the amount of shaft power provided to it by the supercharger's turbine (159). Accordingly, the supercharger's compressor (157) can be accelerated by disconnecting the torque transmitting means (168) through which the excess power provided by the supercharger's turbine (159) is provided to the auxiliary driven mechanism (167), and thus, all the available shaft power energy provided by the supercharger's turbine (159) will be supplied to the supercharger's compressor (157) leading to its acceleration. Deceleration of the supercharger's compressor (157) is provided by opening the valve means (161) provided for controlling the flow of air through the conduit (160) communicating the supercharger's receiver (158) with its surrounding atmospheric air, to partially bleed the pressurized air collecting within the supercharger's compressor receiver (158), which will lead to immediate drop in the mass flow rate and pressure level of the working gases (152) provided to the core engine, and hence to the supercharger's turbine (159), which decreases the shaft power output provided by it to the supercharger's compressor (157).

The pressurized air (152) provided by the supercharger's compressor is actively swept by the rotary ram compressor or the rotary ram-in compressor stage (153) of the core engine, with the density and pressure of the pressurized air (152) supplied to the core engine's compressor (153) being self adjusted according to the ratio between the air feeding and sweeping volumetric rates to and from the supercharger's receiver (158), and with the mass flow rate of working gases within the core engine and the amount of its developed shaft power output being adjusted accordingly.

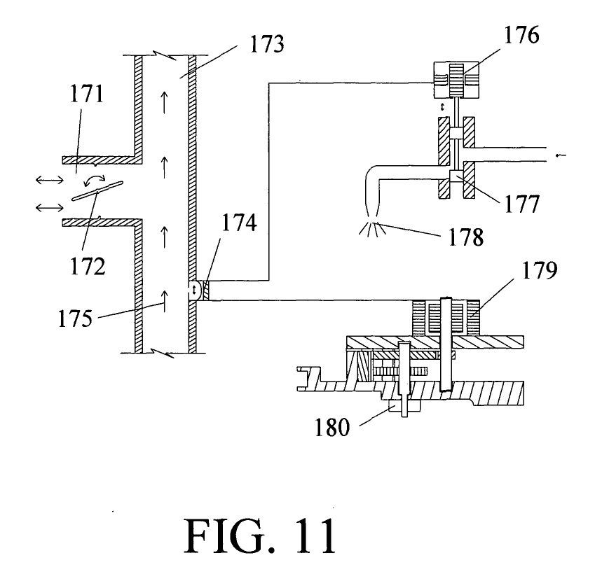

FIG. 11 is a schematic representation of an arrangement of control means used in the supercharged gas turbine engine of FIG. 10.

The arrangement of control means comprises a conduit (171), having a Butterfly valve (172) within it, for communicating the supercharger's receiver (173) with its surrounding atmospheric air; a pressure sensor (174) for monitoring the pressure of air (175) provided by the supercharger's compressor; a linear step motor (176) controlling the position of a plunger (177) which adjusts the rate of fuel supply (178) to the core engine; and a stepping motor (179) controlling the angle of inclination of the vanes (180) of the supercharger's turbine.

To start the supercharged gas turbine engine of this embodiment, the Butterfly valve (172) is widely opened, to provide free communication between the supercharger's receiver (173) and its surrounding atmosphere, and thus, the pressure of air within the supercharger's receiver (175) will be equivalent to that of the surrounding atmospheric air pressure, to avoid chocking of the core engine's compressor, then, the core engine is started using conventional starting means. Once the core engine starts running, the supercharger's rotor will start to accelerate by the shaft power extracted by the supercharger's turbine from the working gases discharged from the core engine's turbine and introduced to it, till the supercharger's compressor reaches a rotational speed at which the volumetric rate with which air is fed to the supercharger's receiver is equal to the volumetric rate with which it is being swept from it. At that point, the Butterfly valve (172) is closed, with the working gases being provided to the core engine's compressor by the supercharger's compressor.

To accelerate the supercharger's compressor, the torque transmitting means through which the excess power provided by the supercharger's turbine is provided to the auxiliary driven mechanism are disconnected, and thus, all the available shaft power energy provided by the supercharger's turbine will be supplied to the supercharger's compressor leading to its acceleration, as described herein before. Deceleration of the supercharger's compressor is provided by opening the Butterfly valve (172) to partially bleed the pressurized air (175) collecting within the supercharger's compressor receiver (173), which will lead to immediate drop in the mass flow rate and pressure level of the working gases provided to the core engine and hence to the supercharger's turbine, which decreases the shaft power output provided by it to the supercharger's compressor, leading to its deceleration, as described herein before.

The pressure sensor (174) monitors the pressure of air (175) provided by the supercharger's compressor and sends correlative signals to both the linear step motor (176) and the stepping motor (179) controlling the rate of fuel supply (178) to the core engine and the angle of inclination of the vanes (180) of the supercharger's turbine respectively.

Further objectives and advantages of the present invention will be apparent to those skilled in the art from the detailed description of the disclosed invention. The present discussion of illustrative embodiments is not intended to limit the spirit and scope of the invention beyond that specified by the claims presented hereafter.

What is claimed is:

1. A supercharged open-cycle gas turbine engine comprising:
a core gas turbine engine for generating shaft power output, said core gas turbine engine includes a multi-stage compressor and a turbine;
a supercharger for supercharging intake air of the core engine, said supercharger includes a rotary ram-in compressor; a receiver; and a turbine having variable-area nozzle assembly and driven by a portion of the working gases discharged from the core engine's turbine;
at least one conduit for communicating the supercharger's receiver with its surrounding atmospheric air, with the said conduit being provided with valve means for controlling the flow of air through it;
at least one pressure sensor for detecting the degree of rise in the pressure of air supplied by the supercharger's compressor;
means for adjusting the area of the nozzles of the supercharger's turbine according to the detected degree of rise in the air pressure;
means for adjusting the rate of fuel supply to the core engine according to the pressure level of air supplied by the supercharger's compressor; and
means for dividing the stream of working gases discharged from the core engine's turbine into two sub-stream portions.

2. The supercharged gas turbine engine of claim 1, wherein the first stage of the said core gas turbine engine's multi-stage compressor is a rotary ram-in compressor.

3. The supercharged gas turbine engine of claim 1, wherein the first stage of the said core gas turbine engine's multi-stage compressor is a rotary ram compressor.

4. The supercharged gas turbine engine of claim 1, wherein the said valve means provided for controlling the flow of air through the conduit communicating the supercharger's receiver with its surrounding atmospheric air is a Butterfly valve.

5. The supercharged gas turbine engine of claim 1, wherein the said means for dividing the stream of working gases discharged from the core engine's turbine into two sub-stream portions are provided with means for changing the ratio with which the said stream of working gases is divided into the said two sub-stream portions.

6. The supercharged gas turbine engine of claim 5, wherein the said means provided for changing the ratio with which the stream of working gases is divided into the two sub-stream portions is a diverter valve.

7. The supercharged gas turbine engine of claim 1, wherein one of the said two sub-stream portions, into which the stream of working gases discharged from the core engine's turbine is divided, is introduced to a thrusting nozzle.

8. The supercharged gas turbine engine of claim 1, wherein one of the said two sub-stream portions, into which the stream of working gases discharged from the core engine's turbine is divided, is introduced to a mechanically independent turbine.

9. The supercharged gas turbine engine of claim 8, wherein the torque provided by the said mechanically independent turbine is supplied to an auxiliary driven mechanism.

10. The supercharged gas turbine engine of claim 9, wherein the said auxiliary driven mechanism is an auxiliary electric generator.

11. A supercharged open-cycle gas turbine engine comprising:
a core gas turbine engine for generating shaft power output, said core gas turbine engine includes a multi-stage compressor and a turbine;
a supercharger for supercharging intake air of the core engine, said supercharger includes a rotary ram-in compressor; a receiver; and a turbine having variable-area nozzle assembly and driven by the working gases discharged from the core engine's turbine;
at least one conduit for communicating the supercharger's receiver with its surrounding atmospheric air, with the said conduit being provided with valve means for controlling the flow of air through it;
at least one pressure sensor for detecting the degree of rise in the pressure of air supplied by the supercharger's compressor;
means for adjusting the area of the nozzles of the supercharger's turbine according to the detected degree of rise in the air pressure; and
means for adjusting the rate of fuel supply to the core engine according to the pressure level of air supplied by the supercharger's compressor.

12. The supercharged gas turbine engine of claim 11, wherein the first stage of the said core gas turbine engine's multi-stage compressor is a rotary ram-in compressor.

13. The supercharged gas turbine engine of claim 11, wherein the first stage of the said core gas turbine engine's multi-stage compressor is a rotary ram compressor.

14. The supercharged gas turbine engine of claim 11, wherein the said valve means provided for controlling the flow of air through the conduit communicating the supercharger's receiver with its surrounding atmospheric air is a Butterfly valve.

15. The supercharged gas turbine engine of claim 11, wherein an auxiliary driven mechanism is connected to the supercharger's turbine through torque transmitting means.

16. The supercharged gas turbine engine of claim 15, wherein the said auxiliary driven mechanism is an electric motor-generator.

17. The supercharged gas turbine engine of claim 15, wherein the said auxiliary driven mechanism is an electric generator.
